(19) United States
(12) Patent Application Publication
(10) Pub. No.: US 2026/0349951 A1
(43) Pub. Date: Nov. 5, 2026

(54) METHOD AND APPARATUS FOR PHYSICAL NETWORK SEGREGATION BASED ON A SINGLE PC

(71) Applicant: STORAGEAN INC., Seoul (KR)

(72) Inventor: DONG GOO YUN, Seoul (KR)

(21) Appl. No.: 19/487,082

(22) PCT Filed: May 23, 2024
(86) PCT No.: PCT/KR2024/007002

§ 371 Date: Nov. 24, 2025

(30) Foreign Application Priority Data
May 23, 2023 (KR) 10-2023-0066393
Jun. 14, 2023 (KR) 10-2023-0075982
Jul. 25, 2023 (KR) 10-2023-0096573
Jan. 26, 2024 (KR) 10-2024-0012738
May 22, 2024 (KR) 10-2024-0066664

(51) Int. Cl. G06F 13/42; G06F 9/455; G06F 11/30

(52) U.S. Cl. CPC G06F 13/4282; G06F 9/45558; G06F 11/302; G06F 2009/45595

(57) ABSTRACT

A single-PC-based physical network segregation system implements physical separation between an internal network and an external network through dedicated hardware in cooperation with a device driver. In a desktop PC environment, the physical network segregation system includes a network segregation control board, network connector, a network selector, and a plurality of M.2 adapter cards respectively coupled to M.2 solid-state drives on which an internal-network operating system and an external-network operating system are installed. According to an operation flow interworking with the device driver, the system electrically connects only one of the internal network or the external network based on execution or activation states of a web browser on a main screen of the operating system or within virtual machine software, thereby maintaining physical network segregation.

### BACKGROUND

### 1. Technical Field

The present invention relates to a conventional physical network segregation environment that uses two personal computers, which provides a high level of security from a security perspective. However, such an environment has been pointed out to suffer from problems including doubled hardware acquisition costs and software license costs due to the use of two personal computers, a large installation space requirement, and high power consumption.

In order to solve the above-described problems, the present invention employs a single personal computer in which an operating system for an internal network and an operating system for an external network are independently provided, and the personal computer is configured to boot into either the internal network operating system or the external network operating system according to a user selection.

In particular, when the personal computer is booted by the operating system for the external network, only a connection to the external network is maintained. On the other hand, when the personal computer is booted by the operating system for the internal network, a connection to the external network is established in installed virtual machine software, while a connection to the internal network is established on a main screen, thereby providing a web browser usage environment through the external network within an internal network usage environment without rebooting the personal computer.

The present invention relates to a physical network segregation technology in which a web browser executed in virtual machine software and/or a web browser executed on a main screen is monitored by a device driver of the present invention, such that a network adapter of the virtual machine software and a network adapter of the main screen are controlled to be in activated or deactivated states. At the same time, control information is transmitted to hardware of the present invention through a PCI Express interface or a low-speed USB interface, such that, when the network adapter of the virtual machine software is activated, a network segregation dongle in which internal and external networks are physically connected selects an external network, and, conversely, when the network adapter of the main screen is activated, the network segregation dongle selects an internal network, thereby maintaining physical network segregation even in a single personal computer environment.

### 2. Background of the Invention

When a personal computer user presses a power button to use a personal computer, the personal computer performs a booting operation. During this process, the personal computer connects to a network regardless of the user's intention. In addition, even after a built-in disk device for user data, on which an operating system is not installed, is recognized, the built-in disk device remains continuously connected. As a result, when the booting of the personal computer is completed and the personal computer becomes ready for use, the built-in disk device for user data remains exposed on the network, thereby placing the personal computer in a state vulnerable to hacking before the user is finally able to use the personal computer.

In order to fundamentally solve these problems, physical network segregation was introduced approximately several years ago and has continued to be implemented. However, as described above, physical network segregation has been configured using two personal computers for a single user, thereby accompanying the above-described problems.

However, from a user perspective, when examining a usage environment of a physical network segregation system configured with two personal computers, there exist inevitable cases in which two personal computers must be used. For example, in a personal computer usage environment in which a user searches for certain information on an external network, such as the Internet, and prepares a report on an internal business network by referring to the searched information, a two-personal-computer environment is inevitably required.

Accordingly, in the present invention, virtual machine software is utilized for access to an external network in order to provide, while using a single personal computer, a usage environment similar to that of using two personal computers as described above, while maintaining physical network segregation.

Meanwhile, a device driver used for single-personal-computer-based physical network segregation according to the present invention monitors web browsers executed in virtual machine software and/or on a main screen. In particular, when web browsers are executed simultaneously in the virtual machine software and on the main screen, network control operations are performed in such a manner that the web browsers on both sides operate continuously without interruption, wherein the network control operations are performed either in a device-driver-driven manner by the device driver or in a hardware-driven manner through a network segregation control unit of a physical network segregation control means, such that network connection or switching operations are repeatedly performed at predetermined periodic intervals.

Meanwhile, when a user does not execute a web browser, the device driver maintains a network in a blocked state. In addition, with respect to a built-in disk device for user data, when the user does not access the disk device, the disk device is also maintained in a blocked state. Accordingly, even when the user executes a web browser and uses a network, the disk device is prevented from being exposed on the network, thereby providing a highly secure personal computer environment.

In this regard, disk connection and disconnection control for a built-in disk device, as described in Korean Registered Patent No. 10-2318716 (filed on Sep. 28, 2018) and Korean Registered Patent No. 10-2320090 (filed on Oct. 5, 2020, titled “Data storage means control device and method having a data protection function through wireless communication with a smartphone”), both owned by the present applicant, may be regarded as one of the background technologies of the present invention.

### SUMMARY

In conventional physical network segregation, a configuration using two personal computers is required. However, physical network segregation based on the use of two personal computers inevitably has disadvantages in that two personal computers must be used to construct a single working environment, and thus has higher deployment costs as well as disadvantages in terms of space requirements, power consumption, and administrative aspects such as maintenance, as compared to the physical network segregation of the present invention implemented using a single personal computer.

FIG. 1 is a diagram illustrating a conventional physical network segregation environment (10) using two personal computers. From a user usage environment perspective, a user who uses a physical network segregation system accesses an Internet network using an external-network personal computer mainframe (11) and a monitor (13) connected thereto to search for reference data necessary for work and displays the reference data on the monitor (13). Thereafter, in order to perform tasks such as preparing a report while viewing an internal-network personal computer mainframe (17) and a monitor (15) connected thereto, two personal computer mainframes (11 and 17) and two monitors (13 and 15) are inevitably required.

Meanwhile, in a conventional physical network segregation environment using two personal computer mainframes (11 and 17), a KVM (keyboard, video monitor, mouse) switch including a switching function (not shown) may be used. However, in a case in which only a single monitor is provided, work is performed while switching between screens of the two personal computers. As a result, even when reference data necessary for work obtained from an external network such as the Internet is displayed, inconvenience is caused in performing work on an internal network while continuously viewing the reference data without screen switching.

In addition, in the case of logical network segregation using a single personal computer (not shown), although there is an effect of improving certain disadvantages pointed out in physical network segregation configured using two personal computers, because virtual machine software that is not natively supported by an operating system for physical network segregation is used, not only are there high introduction costs for the virtual machine software itself, but security vulnerabilities inherent in the virtual machine software have also been continuously pointed out, such that fundamental doubts regarding security remain unresolved.

In particular, among logical network segregation approaches, server-based logical network segregation, which is more widely used, involves excessively high initial deployment costs. As a result, cost competitiveness with respect to the two-personal-computer-based physical network segregation (10) shown in FIG. 1 can be achieved only under a condition in which the system is deployed for a number of users exceeding a certain scale.

Accordingly, single-personal-computer-based physical network segregation according to the present invention maintains the security effect of conventional two-personal-computer-based physical network segregation, while providing solutions to disadvantages that have been pointed out, including high deployment costs, large space requirements, high power consumption, and maintenance-related issues.

In addition, in conventional two-personal-computer-based physical network segregation (10), logical network segregation (not shown), and use of a general personal computer (not shown), a network is connected upon booting of the personal computer, and a built-in disk device is exposed on the connected network, such that the personal computer is in a state vulnerable to hacking at the time of use. In contrast, in single-personal-computer-based physical network segregation according to the present invention, a network is maintained in a blocked state until a user executes a web browser, and even when the network is connected by execution of the web browser, a disk device for user data is maintained in a blocked state unless the user accesses the disk device, thereby preventing the disk device from being exposed on the network even during Internet use.

A single-personal-computer-based physical network segregation method and apparatus according to the present invention comprise: a first network adapter provided for a main screen when an operating system boots; a second network adapter provided for virtual machine software installed in the operating system; a device driver installed in the operating system and configured to monitor web browsers executed on the main screen and/or in the virtual machine software; and physical network segregation control means including an interface conversion unit configured to receive and transmit various status information, a network connection unit to which an internal-network cable and an external-network cable are connected, and a network segregation control unit configured to generate various control signals, including connection control signals for the network connection unit, based on status information received through the interface conversion unit. When the device driver detects that a web browser is executed on the main screen, the first network adapter is switched to an active state and the second network adapter is switched to an inactive state. At the same time, the device driver transmits, to the physical network segregation control means, status information indicating that the web browser of the main screen or the first network adapter is in use, such that the physical network segregation control means connects the internal network in correspondence with a state in which the first network adapter is in use. When the device driver detects that a web browser is executed in the virtual machine software, the second network adapter is switched to an active state and the first network adapter is switched to an inactive state. At the same time, the device driver transmits, to the physical network segregation control means, status information indicating that the web browser of the virtual machine software or the second network adapter is in use, such that the physical network segregation control means connects the external network in correspondence with a state in which the second network adapter is in use. When the device driver detects that web browsers are executed on both the main screen and in the virtual machine software, a network adapter corresponding to a web browser that is executed or activated later is switched to an active state, and a network adapter corresponding to a web browser that is executed or activated earlier is switched to an inactive state. At the same time, the device driver transmits, to the physical network segregation control means, status information of the web browser that is executed or activated later, or status information of the network adapter that is switched to the active state. Accordingly, when the web browser executed or activated later corresponds to the main screen or when the first network adapter is in use, the physical network segregation control means connects the internal network, and when the web browser executed or activated later corresponds to the virtual machine software or when the second network adapter is in use, the physical network segregation control means connects the external network, thereby maintaining physical network segregation.

In addition, the apparatus comprises: a first network adapter provided for a main screen when an operating system boots; a second network adapter provided for virtual machine software installed in the operating system; a device driver installed in the operating system and configured to monitor web browsers executed on the main screen and/or in the virtual machine software; and physical network segregation control means to which an internal-network cable and an external-network cable are connected and which is connected to the device driver through an interface unit. When the device driver detects that a web browser is not executed on the main screen and also detects that a web browser is not executed in the virtual machine software, the first network adapter provided on the main screen and the second network adapter provided in the virtual machine software are each switched to an inactive state. At the same time, the device driver transmits, to the physical network segregation control means, status information indicating that the web browsers on both the main screen and the virtual machine software are not executed, or that both the first network adapter and the second network adapter are in inactive states, thereby causing the physical network segregation control means to maintain a state in which both the internal network and the external network are simultaneously blocked.

In addition, the apparatus comprises: a first network adapter provided for a main screen when an operating system boots; a second network adapter provided for virtual machine software installed in the operating system; a device driver installed in the operating system and configured to monitor web browsers executed on the main screen and/or in the virtual machine software; and physical network segregation control means to which an internal-network cable and an external-network cable are connected and which is connected to the device driver through an interface unit. When the device driver detects that a web browser is executed or later selected and activated on the main screen and/or in the virtual machine software and transmits corresponding status information to the physical network segregation control means, the physical network segregation control means performs a subsequent operation as follows. When it is determined that a web browser is executed only on the main screen, the physical network segregation control means connects an internal network and transmits network connection information to the device driver, thereby causing the device driver to switch the first network adapter of the main screen to an active state and to switch the second network adapter of the virtual machine software to an inactive state. When it is determined that a web browser is executed only in the virtual machine software, the physical network segregation control means connects an external network and transmits network connection information to the device driver, thereby causing the device driver to switch the second network adapter of the virtual machine software to an active state and to switch the first network adapter of the main screen to an inactive state. When it is determined that web browsers are executed simultaneously on the main screen and in the virtual machine software and a current network connection state is an external network connection state, the physical network segregation control means connects an internal network and transmits corresponding network connection information to the device driver, thereby causing the device driver to switch the first network adapter of the main screen to an active state and to switch the second network adapter of the virtual machine software to an inactive state. Thereafter, after a predetermined period of time has elapsed, the physical network segregation control means connects the external network again and transmits corresponding network connection information to the device driver, thereby causing the device driver to switch the first network adapter to an inactive state and to switch the second network adapter to an active state, and such operations are repeatedly performed. When it is determined that web browsers are executed simultaneously on the main screen and in the virtual machine software and the current network connection state is an internal network connection state, the physical network segregation control means connects the external network and transmits corresponding network connection information to the device driver, thereby causing the device driver to switch the second network adapter of the virtual machine software to an active state and to switch the first network adapter of the main screen to an inactive state. Thereafter, after a predetermined period of time has elapsed, the physical network segregation control means connects the internal network again and transmits corresponding network connection information to the device driver, thereby causing the device driver to switch the second network adapter to an inactive state and to switch the first network adapter to an active state, and such operations are repeatedly performed.

In addition, a physical network segregation control means comprises: an interface conversion unit configured to receive status information regarding a web browser that is executed or later activated on a main screen and/or in virtual machine software, or status information regarding a network adapter that is later set to a used state; a network segregation control unit connected to the interface conversion unit and configured to generate an internal-network selection signal or an external-network selection signal according to the received status information; and a network connection unit configured to select and connect an internal network or an external network according to the network selection signal output from the network segregation control unit. In the physical network segregation control means, when the network segregation control unit determines that status information received from the interface conversion unit indicates that the web browser on the main screen is in an activated state, the network connection unit is controlled to connect to the internal network. Conversely, when the network segregation control unit determines that the web browser of the virtual machine software is in an activated state, the network connection unit is controlled to connect to the external network.

In addition, a physical network segregation dongle comprises: a USB Type-C connector for connection to a notebook personal computer; a low-speed USB hub connected to low-speed USB pins provided in the USB Type-C connector and configured to expand the low-speed USB pins into a first low-speed USB connection signal and a second low-speed USB connection signal; a high-speed interface signal conversion unit connected to high-speed USB pins provided in the USB Type-C connector and configured to convert signals into an interface identical to that of an M.2 solid-state drive on which an operating system is installed; a high-speed interface signal switching unit connected to the high-speed interface signal conversion unit; an internal-network M.2 solid-state drive on which an operating system for an internal network is installed and an external-network M.2 solid-state drive on which an operating system for an external network is installed, each connected through the high-speed interface signal switching unit and an M.2 connector; a low-speed interface conversion unit connected to the low-speed USB hub through the first low-speed USB connection signal; a network segregation control unit connected to the low-speed interface conversion unit and configured to receive status information transmitted from a device driver or to output information indicating whether a booted operating system is based on the internal-network M.2 solid-state drive or the external-network M.2 solid-state drive; a network connection unit connected to the low-speed USB hub through the second low-speed USB connection signal and configured to connect an internal network or an external network according to an internal-network or external-network selection signal output from the network segregation control unit; a power supply unit connected to power pins provided in the USB Type-C connector and configured to generate power used internally; and a printed circuit board on which the respective components are mounted. In the physical network segregation dongle, when the control unit determines, based on information received from the device driver through the low-speed interface conversion unit, that a web browser is a web browser of a main screen or that a network adapter of the main screen is being used, the network connection unit connects to the internal network. Conversely, when the control unit determines that the web browser is a web browser of virtual machine software or that a network adapter of the virtual machine software is being used, the network connection unit connects to the external network.

In single-personal-computer-based physical network segregation according to the present invention, physical network segregation can be implemented using a single personal computer, such that reliable security effects resulting from physical network segregation are maintained. In addition, as compared with conventional two-personal-computer-based physical network segregation, the present invention provides advantages including reduced deployment costs, lower power consumption, minimized installation space, reduced heat generation, and a lower likelihood of failures, thereby reducing maintenance frequency.

In addition, from a software perspective, in conventional physical network segregation based on two personal computers, the personal computers have different motherboards and CPUs, and thus different MAC (Media Access Control) addresses that serve as criteria for software licensing, such that separate software licenses are required for each personal computer. However, in single-personal-computer-based physical network segregation according to the present invention, the same motherboard and CPU are used for an operating system for an internal network and an operating system for an external network, thereby maintaining a single MAC address. Accordingly, it is possible to apply a single software license to the operating system, and also to apply a single license to general software used after installation of the operating system, thereby accompanying a reduction in software licensing costs.

In addition, in conventional systems, when a personal computer is booted, a network is connected regardless of a user's intention, thereby placing the personal computer in a state vulnerable to network-based hacking. In contrast, in single-personal-computer-based physical network segregation according to the present invention, even when the personal computer is booted, the network remains in a blocked state unless the user executes a web browser, thereby maintaining a state in which hacking is not possible.

Finally, when a personal computer is booted by an operating system for an external network, only a connection to the external network is maintained. However, when the personal computer is booted by an operating system for an internal network, a connection to an external network is established in installed virtual machine software while a connection to an internal network is maintained on a main screen, thereby maintaining physical network segregation and providing, without rebooting the personal computer, a web browser usage environment for an external network within an internal network usage environment.

### BRIEF DESCRIPTION OF THE DRAWINGS

FIG. 1 is a diagram illustrating a conventional physical network segregation usage environment in which two personal computer mainframes and two monitors are used.

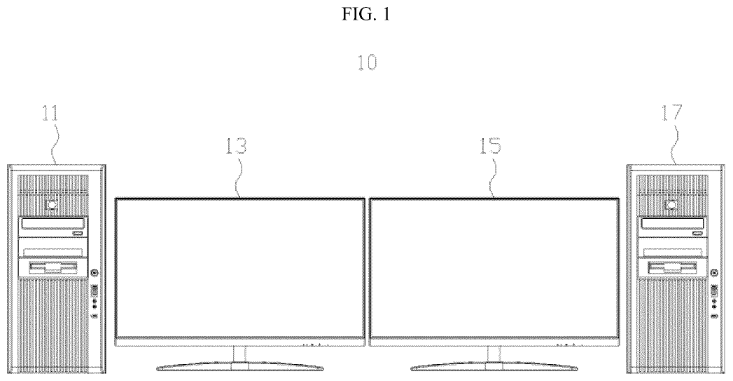

FIG. 2 is a block diagram illustrating physical network segregation based on a single personal computer according to the present invention, in which, under cooperative operation between a device driver and a network segregation control unit, a web browser for an internal network is displayed on a main screen and a web browser for an external network is displayed on a screen of virtual machine software to show a physical network segregation operation.

FIG. 3 is an execution screen of an embodiment illustrating a web browser displayed on a main screen used for an internal network on a monitor (100) shown in the block diagram of FIG. 2, and a web browser displayed in virtual machine software used for an external network.

FIG. 4 is a detailed embodiment of the block diagram of FIG. 2, illustrating a single-personal-computer-based physical network segregation apparatus for a desktop personal computer, which comprises a network-segregation PCIe card, a network-segregation network dongle as a network connection unit, a network selection unit, and an M.2 adapter card to which two M.2 solid-state drives, each having an operating system for an internal network or an external network, are coupled.

FIG. 5 is a circuit configuration of an embodiment of the low-speed USB interface unit provided in FIG. 4.

FIG. 6 is a flowchart of a device driver illustrating a single-personal-computer-based physical network segregation operation according to the present invention.

FIG. 7 is a block diagram of a physical network segregation dongle for implementing physical network segregation for a notebook personal computer according to the present invention.

FIG. 8 is an embodiment of a physical network segregation dongle for a notebook personal computer, which hardware-wise concretizes the block diagram of FIG. 7.

### DETAILED DESCRIPTION OF THE INVENTION

The terminology used herein is for the purpose of describing embodiments only and is not intended to limit the present invention. As used herein, the singular forms include the plural forms unless the context clearly indicates otherwise.

Hereinafter, a single-personal-computer-based physical network segregation according to a preferred embodiment of the present invention will be described in detail with reference to the accompanying drawings.

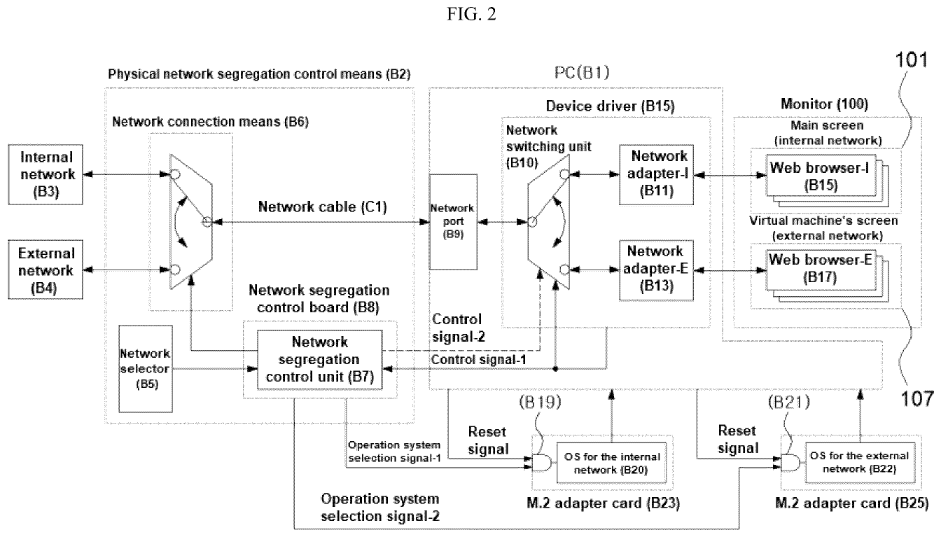

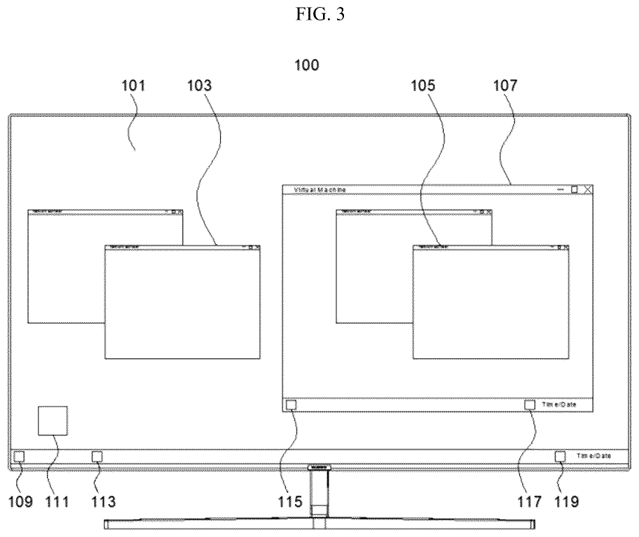

FIG. 2 is a block diagram illustrating single-personal-computer-based physical network segregation according to the present invention. As illustrated in FIG. 2, together with an execution screen of an embodiment shown in FIG. 3, an internal-network web browser (103) displayed on a main screen (101) and an external-network web browser (105) displayed on a virtual machine software screen (107) are shown. According to coordinated operation between a device driver (B15) and a network segregation control unit (B7), physical network segregation is performed. Hereinafter, respective blocks or components will be described with reference to the corresponding reference numerals.

First, a physical network segregation control means (B2) comprises a network segregation control board (B8), a network connection unit (B6), and a network selector (B5). The physical network segregation control means (B2) is configured such that an M.2 solid-state drive (SSD) (B20) on which an operating system for an internal network is installed and an M.2 SSD (B22) on which an operating system for an external network is installed are respectively inserted into two M.2 adapter cards (B23, B25), which are coupled to two M.2 connectors (not shown) provided on a motherboard (not shown) of a personal computer (B1).

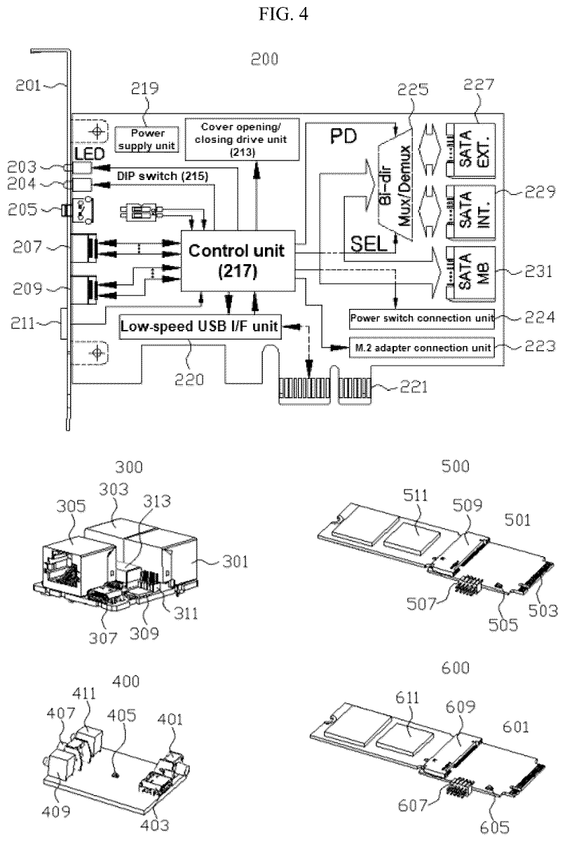

The network segregation control board (B8) corresponds to the physical network segregation card (200) illustrated in FIG. 4. Detailed constituent elements thereof will be described later with reference to the physical network segregation card (200) shown in FIG. 4. Hereinafter, a description will be continued regarding how single-personal-computer-based physical network segregation is configured.

When a user presses a power switch (not shown) of a personal computer (B1), a network segregation control unit (B7), which is included in a physical network segregation control means (B2) installed in a PCI Express slot (not shown) provided on a motherboard (not shown) of the personal computer (B1), performs a boot operation according to a preset value, such as an operating system for an internal network set at a time of factory shipment or an operating system previously selected by a network selector (B5). For purposes of illustration, the following description assumes that the personal computer is currently booted using the operating system for the internal network.

With respect to boot control of an operating system associated with an M.2 adapter card (B23) coupled to an M.2 solid-state drive (SSD) (B20) on which an operating system for an internal network is installed, when a user operates a switch (401) provided on a network selector (B5, 400) while a personal computer (B1) is already booted using the internal-network operating system, and a network segregation control unit (B7, 217) determines that the selected operating system corresponds to the currently booted internal-network operating system, then, when the user subsequently selects one of power options including system shutdown, hibernation, or restart and the personal computer (B1) is powered down, the network segregation control unit (B7) maintains a reset-deasserted state for the M.2 adapter card (B23, 501) coupled to the M.2 SSD (B20, 511) on which the internal-network operating system is installed, thereby allowing rebooting using the internal-network operating system. At the same time, the network segregation control unit maintains a reset signal in an asserted state for the M.2 adapter card (B25, 601) coupled to the M.2 SSD (B22, 611) on which an external-network operating system that is not selected is installed, thereby preventing booting using the external-network operating system.

When a user operates a switch (401) provided on a network selector (B5, 400) while a personal computer (B1) is already booted using an internal-network operating system, and a network segregation control unit (B7, 217) determines that the selected operating system corresponds to an external-network operating system different from the currently booted internal-network operating system, then, upon a subsequent selection by the user of one of power options including system shutdown, hibernation, or restart, causing the personal computer (B1) to be powered down, the network segregation control unit (B7) maintains a reset signal in an asserted state for an M.2 adapter card (B23, 501) coupled to an M.2 solid-state drive (SSD) (B20, 511) on which the internal-network operating system is installed, thereby preventing rebooting using the internal-network operating system. Concurrently, the network segregation control unit maintains a reset-deasserted state for an M.2 adapter card (B25, 601) coupled to an M.2 SSD (B22, 611) on which the external-network operating system is installed, thereby allowing booting using the external-network operating system.

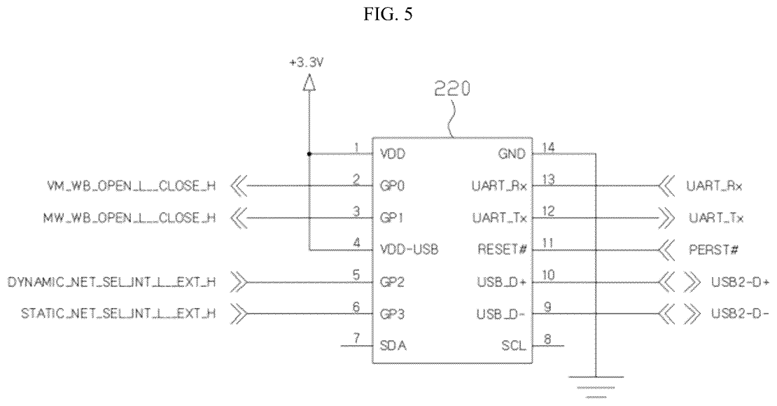

When a personal computer has completed booting, if a user does not open a web browser used for an internal network on a main screen (101) or a web browser used for an external network in virtual machine software (107), the device driver (B15) outputs such a state by driving both a GP0 pin and a GP1 pin of a low-speed USB interface unit (220) illustrated in FIG. 5 to a HIGH state, and transmits the state to a network segregation control unit (B7).

When a user executes a web browser (corresponding to B15, 103) only on a main screen (101), a device driver (B15) switches a network adapter (B11) of the main screen (101) to an active state and switches a network adapter (B13) of virtual machine software (107) to an inactive state. At the same time, the device driver (B15) outputs a LOW state on a GP0 pin and a HIGH state on a GP1 pin of a low-speed USB interface unit (220) illustrated in FIG. 5, and transmits the states to a network segregation control unit (B7).

When a user executes a web browser (corresponding to B17, 105) only in virtual machine software (107), a device driver (B15) switches a network adapter (B13) of the virtual machine software (107), which is used for an external network, to an active state, and switches a network adapter (B11) of a main screen (101) to an inactive state. At the same time, the device driver (B15) outputs a HIGH state on a GP0 pin and a LOW state on a GP1 pin of a low-speed USB interface unit (220) illustrated in FIG. 5, and transmits the states to a network segregation control unit (B7).

When web browsers are executed on both a main screen (101) and in virtual machine software (107), a device driver (B15) switches a network adapter (B11 or B13) corresponding to a web browser (103, 105) that is executed later to an active state, and switches a network adapter (B11 or B13) corresponding to a web browser that is executed earlier to an inactive state. At the same time, the device driver outputs signals to a GP0 pin and a GP1 pin of a low-speed USB interface unit (220) illustrated in FIG. 5 so as to correspond to the main screen (101) or the virtual machine software (107) to which the later-executed web browser (103, 105) belongs.

Meanwhile, when web browsers are open on both a main screen (101) and in virtual machine software (107), a device driver (B15) switches a network adapter (B11 or B13) corresponding to a location to which a web browser (103, 105) later activated by a user, for example by a mouse click (not shown), belongs to an active state, and switches a network adapter (B11 or B13) corresponding to a web browser (103, 105) previously activated to an inactive state. At the same time, the device driver outputs signals to a GP0 pin and a GP1 pin of a low-speed USB interface unit (220) illustrated in FIG. 5 so as to correspond to the main screen (101) or the virtual machine software (107) to which the later-activated web browser (103, 105) belongs.

For reference, activation or deactivation of the network adapters (B11, B13) by a device driver (B15) is performed at a network switching unit (B10) illustrated in the block diagram of FIG. 2.

When the device driver (B15) transmits output results of a GP0 pin and a GP1 pin of the above-described low-speed USB interface unit (220) to a network segregation control unit (B7), the network segregation control unit (B7) reads input states of the GP0 pin and the GP1 pin and outputs corresponding network selection signals to a network segregation network dongle (300), which corresponds to a network connection unit (B6).
\textcircled{1} GP0=HIGH and GP1=HIGH: network connection is blocked.
\textcircled{2} GP0=LOW and GP1=HIGH: an external network connection is enabled.
\textcircled{3} GP0=HIGH and GP1=LOW: an internal network connection is enabled.

Meanwhile, when the device driver (B15) outputs signals to the GP0 pin and the GP1 pin of the low-speed USB interface unit (220) as described below, configuration of the network adapters (B11, B13) is performed under initiative of the network segregation control unit (B7).
\textcircled{4} GP0=LOW and GP1=LOW: network connection control is performed under initiative of the network segregation control unit (B7).

In this case, the network segregation control unit (B7) inputs a DYNAMIC NET SEL_INT_L_EXT_H signal to a GP2 pin configured as an input pin, thereby causing the device driver (B15) to reference a “control signal-2” (indicated by a dotted line) and selectively connect the network adapters (B11, B13) to either an internal network or an external network.

At this time, the network segregation control unit (B7) inputs a control signal to the GP2 pin by alternately outputting LOW and HIGH states at a predetermined time interval. Timing information for the predetermined interval is set when a user selects one of selectable options displayed as 10 seconds, 20 seconds, 30 seconds, . . . , or 60 seconds in a radio-button format on a graphical user interface (GUI, not shown). The device driver (B15) transmits the selected timing information to a register (not shown) provided in the network segregation control unit (B7) through a UART port (UART_Rx, UART_Tx), which is implemented as a universal serial interface in the low-speed USB interface unit (220), thereby configuring a control driving cycle.

FIG. 4 is a diagram concretizing the block diagram of FIG. 2 according to the present invention. As illustrated in FIG. 4, the detailed configuration includes a physical network segregation card (200); a network segregation network dongle (300) corresponding to a network connection unit (B6); a network selection unit (400) implementing a network selector (B5); and M.2 adapter cards (B23, B25) to which an M.2 solid-state drive (SSD) (B20) having an internal-network operating system and an M.2 SSD (B22) having an external-network operating system are respectively coupled. An internal-network (or business-network) M.2 adapter card and M.2 SSD (500) and an external-network (or Internet-network) M.2 adapter card and M.2 SSD (600) are thereby illustrated. Hereinafter, functions of respective components will be described with reference to corresponding reference numerals.

First, components disposed on an exterior side of a PCI Express (PCIe) bracket (201) of a physical network segregation card (200) will be described.

Two LED modules (203, 204) are arranged at an upper portion of the PCIe bracket (201), such that only circular head portions of the LEDs protrude to the exterior of the PCIe bracket (201). When the system is booted by an operating system for an external network, the LED module (203) disposed at an outer upper position is illuminated. When the system is booted by an operating system for an internal network, the LED module (204) disposed at an inner position is illuminated.

A tact (TACT or TACTILE) switch (205) is connected to a control unit (217). When a network selection unit (400) is not connected to a USB Type-C port provided at a lower portion of the PCIe bracket, the tact switch operates as a built-in network selection unit. When the network selection unit (400) is connected, the tact switch operates differently depending on a connection mode. In a wired mode, the tact switch is used to perform an operation test for a shortened duration corresponding to one-tenth of a preset timer value, thereby verifying whether a timer operates properly when an internal disk device is used in conjunction with the timer. In a wireless mode, the tact switch is used for device identification.

Each time the tact switch (205) is pressed, a control unit (217) sets a network selection bit in a toggle manner to select either an internal network or an external network. The network selection bit set in this manner is transmitted, at a subsequent boot, as a control signal for selecting an operating system to be booted, to either an M.2 adapter card (500) coupled to an M.2 solid-state drive (SSD) (511) on which an internal-network operating system is installed or an M.2 adapter card (600) coupled to an M.2 SSD (611) on which an external-network operating system is installed.

Two USB Type-C connectors (207, 209) are used for connecting a network segregation network dongle (300) and a network selection unit (400), respectively. As indicated by markings engraved on a PCIe bracket adjacent to the respective USB Type-C connectors (207, 209), the network segregation network dongle (300) is connected to a USB Type-C connector (207) labeled “ND” (Network Dongle), and the network selection unit (400) is connected to a USB Type-C connector (209) labeled “NS” (Network Selector).

Power pins (not shown) of USB Type-C connectors (207, 209) may receive a +12 V power supplied through a PCI Express (PCIe) edge-finger portion (221), which is input to a power supply unit (219) and converted into a +5 V output voltage corresponding to a standard USB power level. Alternatively, when a low-speed USB interface unit (220), which will be described later, is connected via a separate cable (not shown) to a low-speed USB connection port provided on a motherboard (not shown), a +5 V power supplied from the motherboard may be directly used as an input power source for the USB Type-C connectors (207, 209).

Among a plurality of pins provided in a USB Type-C connector (209) to which a network selection unit (400) is connected, a network selection signal output from the network selection unit (400) is electrically connected to a control unit (217). According to a signal level of the network selection signal, the control unit (217) and a control unit (309) provided in a network segregation network dongle (300) recognize network selection information set by a user in a current state.

In addition, another pin of the USB Type-C connector (207) to which the network segregation network dongle (300) is connected receives a network-cable disconnection status signal generated by the network segregation network dongle (300) as a result of monitoring a connection state of a PC-side network cable (not shown), and the signal is input to the control unit (217).

An antenna connection terminal (211) is configured such that an external Bluetooth antenna is coupled thereto when the physical network segregation card (200) is operated in a wireless mode according to a setting of a DIP switch (215).

The DIP switch (215) includes at least two switch knobs. A first switch knob is used to set whether a wireless communication function block built into the control unit (217) is deactivated to operate the system in a wired mode or activated to operate the system in a wireless mode. A second switch knob is used to configure application of a timer function to a built-in disk device for user data connected to SATA connectors (227, 229). Specifically, the second switch knob sets whether, after a user switches the disk device to a connected state, the disk device is automatically switched to a disconnected state when a preset timer expires, or whether the disk device remains in the connected state until the user manually switches it to a disconnected state.

A cover opening/closing drive unit (213) is configured to drive a solenoid (not shown) functioning as a locking mechanism, optionally in conjunction with a fingerprint identification device (not shown) or a similar authentication device. This configuration prevents a user of a physical-network-segregated PC based on a single PC from arbitrarily opening a side cover of a desktop PC, manipulating a DIP switch (215) for wired or wireless configuration, or cross-connecting cables of a built-in disk device for user data connected to a physical network segregation card (200), without authorization from an administrator.

When a wireless communication function block integrated in a control unit (217) is activated, a network selection unit (400) connected via USB Type-C connectors (207, 209) may be functionally replaced by virtual buttons provided by an application installed on a user's smartphone (not shown), such that a physical connection of the network selection unit (400) is not required. However, since a network segregation network dongle (300) requires power, the network segregation network dongle (300) remains connected to the USB Type-C connector (207) provided on the physical network segregation card (200).

As described above, a power supply unit (219) receives a +12 V voltage from a PCI Express (PCIe) edge-finger portion (221) and generates operating power used within the physical network segregation card (200). When required, the power supply unit (219) further generates a +5 V power supplied to the USB Type-C connectors (207, 209). For this purpose, a DC-to-DC step-down converter (not shown) is employed to generate required power levels.

A low-speed USB interface unit (220) provides an interface between the control unit (217) and a device driver (B15). As illustrated in FIG. 4, the low-speed USB interface unit (220) may be implemented using a PCI Express-to-USB 2.0 conversion integrated circuit (not shown) connected via a PCIe edge-finger portion (221). Alternatively, the control unit (217) may be connected via a separate cable (not shown) to a box-type connector (not shown) that accesses a USB 2.0 port (not shown) provided on a motherboard (not shown).

With respect to a connection between the control unit (217) and a connector provided in the low-speed USB interface unit (220), when the control unit (217) supports USB 2.0 interface pins, the connection may be implemented directly using USB 2.0 signals. Alternatively, when it is desired to interface USB 2.0 signals via a universal serial interface, the connection may be implemented using a low-speed USB-to-UART (Universal Asynchronous Receiver/Transmitter) conversion integrated circuit, a low-speed USB-to-I2C conversion integrated circuit, or a low-speed USB-to-GPIO (General-Purpose Input/Output) conversion integrated circuit.

When a low-speed USB-to-GPIO conversion integrated circuit is used, designated pins of the conversion integrated circuit are defined as input pins or output pins, and the conversion integrated circuit is connected to interface with the control unit (217) according to corresponding signal levels. An example of an embodiment applying such a configuration to the present invention will be described in further detail with reference to FIG. 5.

When SATA connectors (227, 229) are provided for connecting a built-in disk device for user data, a 3.5-inch hard disk drive (not shown) or a 2.5-inch solid-state drive (SSD) (not shown) may be connected. When an M.2 SSD connector (not shown) is provided, an M.2 SSD (not shown) may be connected and used in conjunction with M.2 adapter cards (501, 601).

When the SATA connectors (227, 229) are used for connecting the built-in disk device for user data, the SATA connectors (227, 229) are connected to a bidirectional multiplexer/demultiplexer (225). The bidirectional multiplexer/demultiplexer (225) is further connected to a motherboard-side SATA connector (331) and is connected, via a separately provided SATA cable (not shown), to a SATA connector (not shown) provided on the motherboard.

A bidirectional multiplexer/demultiplexer (225) is connected to a SATA connector (229) to which a disk device (not shown) for user data associated with an internal network is connected, and to a SATA connector (227) to which a disk device (not shown) for user data associated with an external network is connected.

When a PC in which a physical network segregation card (200) is installed is booted using an M.2 SSD (511) on which an operating system for an internal network is installed, a control unit (217) outputs, as a disk selection signal (SEL) for the bidirectional multiplexer/demultiplexer (225), a signal corresponding to the SATA connector (229) to which the internal-network user-data disk device (not shown) is connected. In addition, depending on an operation by a user of a connection/disconnection switch (407) for a built-in disk device for user data, which is provided on one side of a network selector (400), the control unit (217) outputs a PD (Power Down) signal in either a LOW state or a HIGH state.

When the PD signal output from the control unit (217) is in a LOW state, the bidirectional multiplexer/demultiplexer (225) connects, based on the disk selection signal, the internal-network user-data disk device (not shown) when the system is booted using the internal-network operating system, and connects the external-network user-data disk device (not shown) when the system is booted using the external-network operating system.

Conversely, when the PD signal output from the control unit (217) is in a HIGH state, power supplied to the bidirectional multiplexer/demultiplexer (225) is interrupted regardless of a state of the disk selection signal. As a result, both the internal-network user-data built-in disk device (not shown) and the external-network user-data built-in disk device (not shown) are switched to a disconnected state.

An M.2 adapter connection unit (223) includes an internal-network operating-system connection connector (not shown) and an external-network operating-system connection connector (not shown). The internal-network operating-system connection connector is connected, via a separately provided cable (not shown), to a connection port (507) provided on an M.2 adapter card (501) to which an M.2 solid-state drive (SSD) (511) storing an operating system for an internal network is coupled. The external-network operating-system connection connector is connected, via a separately provided cable (not shown), to a connection port (607) provided on an M.2 adapter card (601) to which an M.2 SSD (611) storing an operating system for an external network is coupled.

A power switch connection unit (224) is configured such that a two-wire integrated wire harness connected between a PC power switch (not shown) and header pins (not shown) for power-switch connection provided on a motherboard (290) is separated from the motherboard (290). The wire harness separated from the motherboard is then connected to a male-type pin terminal (not shown) protruding from an upper-right portion of a Y-shaped wire harness (not shown) additionally provided for the present invention, while matching polarity colors of the wires (red, black). Subsequently, a female-type housing connector (not shown) provided on an upper-left portion of the Y-shaped wire harness is connected to a 2-pin header having a 2.54-mm pitch, the header constituting a power switch connection unit (324).

Subsequently, a female-type housing connector (not shown) provided at a lower portion of the Y-shaped wire harness (not shown) is connected to header pins (not shown) for a power switch provided on a motherboard (not shown), such that polarities (or corresponding wire colors) are matched.

A pin to which a red wire of the Y-shaped wire harness (not shown) is connected, corresponding to a positive (+) polarity of the power-switch header pins (not shown), is connected to an arbitrary input/output (I/O) pin provided in the control unit (217). Through this connection, a signal indicating that the PC power switch (not shown) has been pressed is transmitted to the control unit (217). Alternatively, a power-switch control signal output from the control unit (217) is transmitted to the power-switch header pins provided on the motherboard (not shown). The network segregation dongle (300) includes three RJ45 Ethernet connectors. A first RJ45 Ethernet connector (305), disposed adjacent to a USB Type-C connector (307), is used for connection to a network port (B9) provided on the PC (B1). Of two RJ45 Ethernet connectors arranged side by side on an opposite side, one connector (301) is connected to a network cable (B3) for an internal network, and the other connector (303) is connected to a network cable (B4) for an external network

A network segregation network dongle (300) corresponds to the network connection means (B6) illustrated in the block diagram of FIG. 2. The network segregation network dongle (300) is connected, via a separate USB cable (not shown), to a USB Type-C connector (209) engraved with “ND (Network Dongle)” and provided on an exterior of a PCI Express (PCIe) bracket (201) of a physical network segregation card (200). The network segregation network dongle (300) receives power supplied from the physical network segregation card (200), receives a reset signal from a control unit (217) corresponding to a network segregation control unit (B7), and receives, from a device driver (B15), status information indicating whether a web browser has been executed, together with a network selection signal. In addition, the network segregation network dongle (300) transmits to the control unit (217) status information indicating whether a network cable (C1) connected to a PC has been disconnected.

The network segregation network dongle (300) includes three RJ45 Ethernet connectors. A first RJ45 Ethernet connector (305), disposed separately adjacent to a USB Type-C connector (307), is used for connection to a network port (B9) provided on a PC (B1). Of the two RJ45 Ethernet connectors disposed side by side on an opposite side, one is an RJ45 Ethernet connector (301) to which an internal-network cable (B3) is connected, and the other is an RJ45 Ethernet connector (303) to which an external-network cable (B4) is connected.

Although not illustrated in FIG. 4, the network segregation network dongle (300) includes, as a constituent element thereof, a bidirectional multiplexer/demultiplexer integrated circuit (IC) for Ethernet signals (not shown). Accordingly, network signals from an RJ45 Ethernet connector (301) to which an internal-network cable (B3) is connected are coupled via a magnetic coil (313) for signal isolation, and network signals from an RJ45 Ethernet connector (303) to which an external-network cable (B4) is connected are likewise coupled via the magnetic coil (313).

A control unit (309) receives, via the USB Type-C connector (307), status information relating to execution of a web browser. The control unit (309) then transmits a control signal to a bidirectional multiplexer/demultiplexer (not shown) disposed on a lower surface of the network segregation network dongle (300). In response to the control signal, the bidirectional multiplexer/demultiplexer selects one of an internal-network signal (B3) or an external-network signal (B4), and transmits the selected signal, via a cable (C1) connected to an RJ45 Ethernet connector (305), to a network port (B9) provided on a PC (B1).

However, when a signal received by the control unit (309) and indicating whether a web browser has been executed is determined to indicate that no web browser has been executed, a PD (Power Down) pin of the bidirectional multiplexer/demultiplexer (not shown) is set to a HIGH state, thereby blocking both the internal network (B3) and the external network (B4).

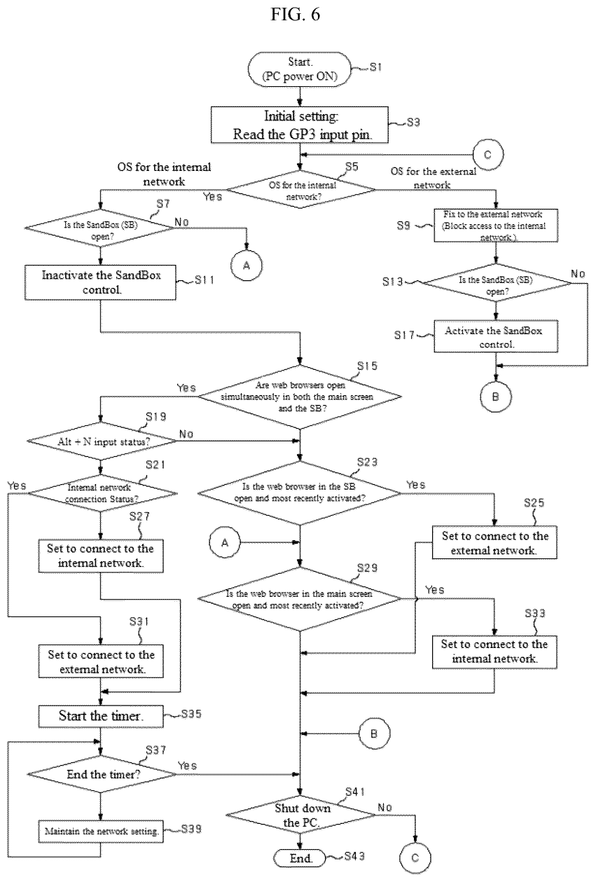

Through the above-described operation, when a user does not execute a web browser on a main screen (101) used for an internal network or within virtual machine software (107) used for an external network on a PC (B1), the network segregation network dongle (300) blocks network signals, thereby preventing the PC (B1) from being exposed to a network. Coordinated operations related thereto, including interaction with a device driver (B15), will be described in further detail with reference to the block diagram of FIG. 2, the embodiment illustrated in FIG. 4, and an operation flow diagram illustrated in FIG. 6.

As described above, a network selection unit (400) is connected, via a separately provided USB cable (not shown), to a USB Type-C connector (403), which is connected to a USB Type-C connector (211) provided adjacent to a PCI Express (PCIe) bracket (201) and engraved with “NS”.

A network selection switch (401) is used when a PC (B1) is already booted and in operation and a different operating system is to be booted, such as switching from an operating system for an internal network to an operating system for an external network, or vice versa.

The USB Type-C connector (403) receives a +5 V power supply from a physical network segregation card (200), receives network-related signals indicating a connection state together with a driving signal for an LED (405), and transmits, to a network segregation control unit (B7) corresponding to a control unit (217) illustrated in FIG. 4, a signal generated by the network selection switch (401) and a signal for connecting or disconnecting a built-in disk device for user data.

An LED (405) is illuminated in response to a driving signal output from a control unit (217). When the system is booted using an M.2 SSD (B20), corresponding to reference numeral (511) in FIG. 4, on which an operating system for an internal network is installed, the LED (405) is illuminated in green. When the system is booted using an M.2 SSD (B22), corresponding to reference numeral (611) in FIG. 4, on which an operating system for an external network is installed, the LED (405) is illuminated in red.

When a user presses a network selection switch (401), the LED (405) alternately blinks between a color corresponding to a currently booted operating system and a different color, thereby indicating to the user that the operation of the network selection switch (401) has been transmitted to, and recognized by, the control unit (217).

In addition, when a PC (B1) is booted using an M.2 SSD (511) on which an operating system for an internal network is installed, a current network connection state established via a network connection means (B6) is displayed as either an internal-network connection or an external-network connection depending on whether a web browser has been executed or activated on a main screen (101) or within virtual machine software (107). For this purpose, an LED (not shown), separate from the LED (405) indicating the booted operating system, is provided to display the network connection state.

A connection/disconnection switch (407) for a built-in disk device for user data is used to selectively connect or disconnect, in a toggle manner upon actuation of the switch (407), a built-in disk device (not shown) for user data connected to SATA connectors (227, 229).

An LED (409) indicating a connection status of a built-in disk device for user data associated with an external network displays a connected state (illuminated) or a disconnected state (extinguished) of the built-in disk device (not shown) in response to actuation of the connection/disconnection switch (407). Likewise, an LED (411) indicating a connection status of a built-in disk device for user data associated with an internal network displays a connected state (illuminated) or a disconnected state (extinguished) of the built-in disk device (not shown) in response to actuation of the connection/disconnection switch (407).

FIG. 5 illustrates a circuit configuration of an embodiment of the low-speed USB interface unit provided in FIG. 4. Hereinafter, a detailed description is provided according to pin numbers of an integrated circuit (IC) used in the embodiment, together with corresponding pin names and assigned signal names.

Pin 1 is a power pin. In the physical network segregation card (200) according to the present invention, a +3.3 V voltage is used as an internal power supply, and therefore Pin 1 is connected to the +3.3 V internal power source.

Pin 2 is a general-purpose input/output (GPIO) pin, and its pin name is GP0. Pin 2 is configured as an output pin. When a web browser is executed within virtual machine software used for an external network, Pin 2 outputs a signal at a “LOW” logic level. When the web browser is closed, Pin 2 outputs a signal at a “HIGH” logic level. The signal assigned to Pin 2 is designated as VM_WB_OPEN_L_CLOSE_H.

Pin 3 is a general-purpose input/output (GPIO) pin, and its pin name is GP1. Pin 3 is configured as an output pin. When a web browser is executed on a main screen used for an internal network, Pin 3 outputs a signal at a “LOW” logic level. When the web browser is closed, Pin 3 outputs a signal at a “HIGH” logic level. The signal assigned to Pin 3 is designated as MW_WB_OPEN_L_CLOSE_H.

Pin 4 is a power pin. In the physical network segregation card (200) according to the present invention, a +3.3 V voltage is used as an internal power supply, and therefore Pin 4 is connected to the +3.3 V internal power source.

Pin 5 is a general-purpose input/output (GPIO) pin, and its pin name is GP2. Pin 5 is configured as an input pin. The control unit (217) outputs, to Pin 5, a control signal generated by referring to at least one of a GP0 signal from Pin 2 and a GP1 signal from Pin 3. The signal assigned to Pin 5 is designated as DYNAMIC_NET_SEL_INT_L_EXT_H.

When the control unit (217) provided in the physical network segregation card (200) initiates control of network connection or disconnection by outputting a corresponding control signal, the device driver (B15) refers to the control signal. When the control signal is at a “LOW” logic level, the device driver (B15) designates a network adapter of the main screen as active and designates a network adapter of the virtual machine software as inactive. Conversely, when the control signal is at a “HIGH” logic level, the device driver (B15) designates the network adapter of the main screen as inactive and designates the network adapter of the virtual machine software as active.

In contrast, when the device driver (B15) initiates control of network connection or disconnection, the control signal is output by the device driver (B15) to the control unit (217). In this case, the control unit (217) refers to the control signal and switches a built-in disk device for user data to a connected state when the control signal is at a “LOW” logic level, and switches the built-in disk device for user data to a disconnected state when the control signal is at a “HIGH” logic level.

Pin 6 is a general-purpose input/output (GPIO) pin, and its pin name is GP3. Pin 6 is configured as an input pin. When a signal output from the control unit (217) is at a “LOW” logic level, the signal indicates that the system has been booted using the M.2 SSD (511) on which an internal-network operating system is installed. When the signal is at a “HIGH” logic level, the signal indicates that the system has been booted using the M.2 SSD (611) on which an external-network operating system is installed.

The device driver (B15) receiving the signal controls network connections and operation of the virtual machine software differently depending on whether the system has been booted using the internal-network operating system or the external-network operating system. Details thereof will be described in further detail with reference to the operation flow diagram illustrated in FIG. 6.

Pin 7 is a pin used as an SDA signal pin for data transmission in a serial interface employing an I2C communication method. In the present invention, however, the serial interface may be implemented using another communication method, such as a UART interface, in conjunction with a corresponding clock or timing signal.

Pin 8 is a pin used as an SCL signal pin for transmitting a clock signal in a serial interface employing an I2C communication method.

Pins 9 and 10 are pins used for a low-speed USB interface. The pins may be connected to a motherboard via a PCIe edge-finger unit (221) by means of a PCI Express-to-low-speed USB conversion integrated circuit (not shown). Alternatively, as described above, the pins may be connected to a low-speed USB connection port provided on the motherboard via a connector (not shown) provided in the low-speed USB interface unit (220) using a separate cable (not shown).

However, when the connector (not shown) provided in the low-speed USB interface unit (220) is connected to the low-speed USB port provided on the motherboard via the separate cable, not only low-speed USB signals but also a +5 V power supply are provided from the motherboard. Accordingly, the supplied +5 V power may be used to supply power to power pins of the USB Type-C connectors (207, 209) provided on the physical network segregation card (200).

Pin 11 is a reset pin having a pin name RESET #. The reset pin is electrically connected to a PERST #pin, which is a reset signal pin provided in the PCIe edge-finger unit (221).

Pins 12 and 13 are universal serial interface pins implementing a UART (Universal Asynchronous Receiver/Transmitter) interface. The pins are connected to the control unit (217) and may be used in place of GPIO pins including Pins 2, 3, 5, and 6.

In this case, when the device driver (B15) operates in a 64-bit operating system environment, the device driver may transmit and receive multi-bit status information and control data in a single transmission unit. Accordingly, when interfacing with third-party software or when a larger number of status bits and control bits are required, the UART interface may be more effectively utilized.

Pin 14 is a ground (GND) pin.

FIG. 6 is an operation flow diagram of the device driver (B15), illustrating a physical network segregation operation based on a single PC according to the present invention. The following description explains how physical network segregation based on a single PC is achieved through coordinated operation with the detailed functional blocks described above with reference to FIGS. 2 to 5.

As a start step, when power to the PC is turned on (S1), the device driver (B15), as an initial step, configures the system to the following initial states.
\textcircled{1} GP0=HIGH→External network connection is blocked.
\textcircled{2} GP1=HIGH→Internal network connection is blocked.
\textcircled{3} A network adapter (B13) associated with sandbox virtual machine software (107) used for an external network→Deactivated (i.e., not in use).
\textcircled{4} A network adapter (B11) of the main screen (101)→Deactivated (i.e., not in use).

Subsequently, the device driver (B15) reads a signal level input to the GP3 input pin of the low-speed USB interface unit (220) provided in the physical network segregation card (200) (S3).

In determining whether the system has been booted using an operating system for an internal network or an operating system for an external network (S5), an operation corresponding to booting using the external-network operating system, which follows a relatively simpler control process, will first be described.

When an input signal at the GP3 pin of the low-speed USB interface unit (220) is at a HIGH level, the device driver (B15) determines that the PC has been booted using the M.2 SSD (611) on which an operating system for an external network is installed (S5).

When the PC is booted using the external-network operating system, the device driver (B15) fixes the network connection means (B6) provided in the physical network segregation control means (B2) to the external network so that access to the internal network is disabled. For this purpose, the device driver (B15) performs the following control operations on the integrated circuit of the low-speed USB interface unit (220) illustrated in FIG. 5 (S9):
\textcircled{1} GP0=LOW→the external network connection is enabled.
\textcircled{2} GP1=HIGH→the internal network connection is blocked.
\textcircled{3} The network adapter (B13) of the virtual machine software (107), used for the external network, is set to an activated state (i.e., in use).
\textcircled{4} The network adapter (B11) of the main screen (101) is set to an activated state (i.e., in use).

As a result of performing operation \textcircled{1}, the network connection means (B6) included in the physical network segregation control means (B2) establishes a hardware-level connection to the external network (B4) in accordance with a control signal output from the network segregation control unit (B7). Accordingly, a network signal path is formed from the external network (B4) to a network port (B9) provided on a motherboard (not shown) of the PC (B1) via a network cable (C1) connected to the network connection means (B6).

As a result, even when both the network adapter (B11) of the main screen (101) and the network adapter (B13) of the virtual machine software (107) are activated and set to an in-use state, all web browsers executed in both environments are connected exclusively to the external network (B4).

Subsequently, the device driver (B15) checks (S13) whether Sandbox, which is the virtual machine software (107) integrated into the operating system, is executed and in an open state. When Sandbox is determined to be open, the device driver (B15) performs an activation process (S17) using control functions provided within Sandbox, thereby enabling user access to resources including a network connection, a clipboard, shared folders, video, microphone, and printer. Thereafter, the device driver proceeds to a step of checking whether the PC is to be shut down (S41). When Sandbox is determined to be in a closed state, the device driver immediately proceeds to the step of checking whether the PC is to be shut down (S41).

Unless the PC is shut down, the step of determining which operating system has been used for booting (S5) and the step of checking whether the PC is to be shut down (S41) are repeatedly performed. This completes the description of the case in which the PC is booted using an external-network operating system. A description of the case in which the PC is booted using an internal-network operating system will now be provided.

When the PC (B1) is booted using an operating system for an internal network (S5), the device driver (B15) checks (S7) whether Sandbox, which is the virtual machine software (107), has been executed and is in an open state.

When Sandbox is determined to be open, the device driver (B15) performs a deactivation process (S11) using control functions provided within Sandbox such that user access to resources including a clipboard, shared folders, video, microphone, and printer is disabled, while excluding network access. Subsequently, the device driver determines (S15) whether web browsers are simultaneously open on the main screen (101) and within Sandbox (107). If it is determined that web browsers are not simultaneously open, or if web browsers are simultaneously open but it is determined (S19) that a user has not input a predefined hotkey (for example, Alt+N), the device driver determines that network connection is required only for the environment in which a web browser has been activated most recently. Accordingly, the device driver proceeds to a next step (S23), in which a network connection is established only for the main screen (101) or the virtual machine software (107) corresponding to the later-activated web browser.

If, in the step of determining whether Sandbox, which is the virtual machine software (107), has been executed and is in an open state (S7), it is determined that Sandbox is not open, the process proceeds to step S29.

The device driver (B15) determines (S23), within Sandbox, which is the virtual machine software (107), whether a web browser is open and whether the web browser is in a most recently activated state.

When the determination result in step S23 is affirmative, the device driver (B15) performs the following processing in step S25.
\textcircled{1} GP0=LOW→Connection to an external network is enabled.
\textcircled{2} GP1=HIGH→Connection to an internal network is blocked.
\textcircled{3} A network adapter (B13) of Sandbox, which is virtual machine software (107) used for an external network→Activated (i.e., set to an in-use state).
\textcircled{4} A network adapter (B11) of the main screen (101)→Deactivated (i.e., set to a not-in-use state).

When the determination result in step S23 is negative, the device driver (B15) proceeds to a next step S29. In addition, when the determination result in step S7 indicates that Sandbox is not open, the process likewise proceeds to step S29.

The device driver (B15) determines (S29) whether a web browser is open on the main screen (101) and whether the web browser on the main screen (101) is in a most recently activated state.

When the determination result in step S29 is affirmative, the device driver (B15) performs the following processing in step S33.
\textcircled{1} GP0=HIGH→Connection to an external network is blocked.
\textcircled{2} GP1=LOW→Connection to an internal network is enabled.
\textcircled{3} A network adapter (B13) of Sandbox, which is virtual machine software (107) used for an external network→Deactivated (i.e., set to a not-in-use state).
\textcircled{4} A network adapter (B11) of the main screen (101)→Activated (i.e., set to an in-use state).

When the determination result in step S29 is negative, the device driver (B15) determines whether the PC (B1) is in a shutdown state (S41). If it is determined that the PC (B1) is not in a shutdown state, the process returns to the operating system determination step (S5). If it is determined that the PC (B1) is in a shutdown state (S41), various settings are reset to initial default values, and the PC is shut down (S43).

Meanwhile, when it is determined in step S15 that web browsers are simultaneously open on the main screen (101) and within Sandbox, which is the virtual machine software (107), and when it is further determined in the subsequent step S19 that a hot key (Alt+N) has been input by a user, the device driver (B15) performs control such that the web browser on the main screen (101) and the web browser within Sandbox (107) are continuously displayed without network disconnection. Specifically, in order to ensure that sufficient buffer memory is filled when a network connection is established in buffer memory (not shown) allocated in a main memory (not shown) of the PC (B1) at the time each web browser is launched, the device driver (B15) alternately connects an internal-network connection (B3) for the main screen (101) and an external-network connection (B4) for the virtual machine software (107) at a periodic interval. The periodic interval is selected by the user via a separate graphical user interface (GUI) from among predefined time values of 10 seconds, 20 seconds, . . . , or 60 seconds.

For this purpose, in step S21, the device driver (B15) determines whether a network that is currently connected is the internal network (B3) or the external network (B4).

If the determination result by the device driver (B15) indicates that a current network connection state corresponds to an external network (B4), the process proceeds to step S27, in which the following processing is performed.
\textcircled{1} GP0=HIGH→Connection to the external network is blocked.
\textcircled{2} GP1=LOW→Connection to the internal network is enabled.
\textcircled{3} A network adapter (B13) of Sandbox, which is virtual machine software (107) used for an external network→Deactivated (i.e., set to a not-in-use state).
\textcircled{4} A network adapter (B11) of the main screen (101)→Activated (i.e., set to an in-use state).

Meanwhile, if the determination result by the device driver (B15) in step S21 indicates that the current network connection state corresponds to an internal network (B3), the process proceeds to step S31, in which the following processing is performed.
\textcircled{1} GP0=LOW→Connection to the external network is enabled.
\textcircled{2} GP1=HIGH→Connection to the internal network is blocked.
\textcircled{3} A network adapter (B13) of Sandbox, which is virtual machine software (107) used for an external network→Activated (i.e., set to an in-use state).
\textcircled{4} A network adapter (B11) of the main screen (101)→Deactivated (i.e., set to a not-in-use state).

After completion of the processing in step S27 or step S31 according to the determination result regarding the current network connection state in step S21, the device driver (B15) starts a timer (not shown) in step S35.

The device driver (B15) determines in step S37 whether the timer started in step S35 has expired. Until the timer expires, the device driver (B15) maintains (S39) the network configuration state that was established in step S27 or step S31.

When it is determined in step S37 that the timer started in step S35 has expired, the device driver (B15) determines in step S41 whether the PC (B1) is in a shutdown state. If the PC (B1) is determined not to be in the shutdown state, the device driver (B15) returns to the operating-system determination step (S5) and repeatedly performs operations between step S5 and step S41 as described above.

If it is determined that the PC (B1) is in the shutdown state, all configuration states are reset to their initial values, and the entire operation process is terminated (S43).

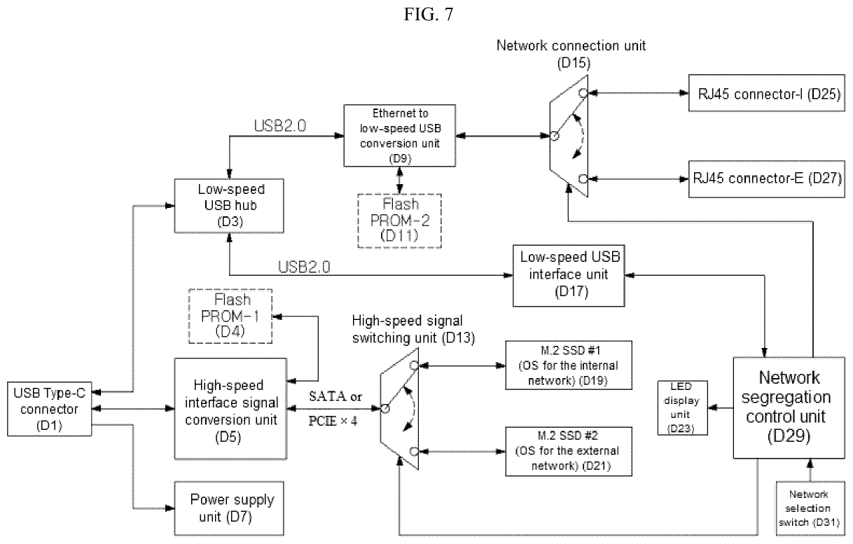

FIG. 7 is a block diagram illustrating a physical network segregation dongle (700) for a notebook PC according to the present invention. A detailed description of the dongle will be provided below with reference to respective functional blocks denoted by corresponding reference numerals.

A USB Type-C connector (DI) is connected to a USB Type-C port (not shown) provided on a notebook PC (not shown) by using a separately provided USB cable (not shown).

A low-speed USB hub (D3) is connected to low-speed USB interface signal pins provided in the USB Type-C connector (D1), and is used to generate and expand a first low-speed USB interface signal and a second low-speed USB interface signal.

A high-speed interface signal conversion unit (D5) is connected to high-speed USB interface signal pins provided in the USB Type-C connector (D1). When a notebook PC in use supports a Thunderbolt interface and an M.2 SSD in use supports a PCI Express interface compliant with an NVMe standard, the high-speed interface signal conversion unit (D5) converts a Thunderbolt signal into a PCI Express interface signal. When the notebook PC does not support a Thunderbolt interface, the high-speed interface signal conversion unit (D5) converts a high-speed USB signal into either a SATA interface signal or a PCI Express interface signal, depending on an interface conversion integrated circuit employed, such that the converted signal is compatible with an interface of an M.2 SSD used for installation of an operating system.

A power supply unit (D7) includes a DC-to-DC converter and peripheral components thereof. The power supply unit (D7) receives a +5 V power supplied from the notebook PC through a power pin provided in the USB Type-C connector (DI), and generates a +3.3 V power used internally within the physical network segregation dongle (700).

An Ethernet-to-low-speed USB conversion unit (D9) performs a function of converting an Ethernet network signal transmitted through a network connection unit (D15) into a low-speed USB interface signal.

Flash PROM-1 (D4) and Flash PROM-2 (D11) are used to store various configuration information required for operation of the high-speed interface signal conversion unit (D5) and the Ethernet-to-low-speed USB conversion unit (D9). However, when the high-speed interface signal conversion unit (D5) or the Ethernet-to-low-speed USB conversion unit (D9) includes an embedded Flash PROM therein, the Flash PROM-1 (D4) and/or the Flash PROM-2 (D11) may be omitted.

A network connection unit (D15) is connected to a network signal of an RJ45 connector-I (D5), corresponding to reference numeral (301) in FIG. 4, to which an internal-network cable (B3) is connected, and is further connected to a network signal of an RJ45 connector-E (D27), corresponding to reference numeral (303) in FIG. 4, to which an external-network cable (B4) is connected. Based on a network selection signal output from a network segregation control unit (D29), one of the internal network (B3) and the external network (B4) is selectively connected and transmitted to the Ethernet-to-low-speed USB conversion unit (D9).

In addition, when the control unit outputs a PD (Power Down) signal at a “HIGH” level, power supplied to the network connection unit (D15) is interrupted, such that neither the internal network nor the external network (B3, B4) is transmitted through the network connection unit (D15).

The low-speed USB interface unit (D17) employs the same integrated circuit and provides the same function as the low-speed USB interface unit (220) provided in the physical network segregation card (200) illustrated in FIG. 4. The low-speed USB interface unit (D17) is connected to at least one low-speed USB interface signal generated by the low-speed USB hub (D3), and is further connected to the network segregation control unit (D29) via GPIO (general-purpose input/output) lines and via a universal serial interface, such as a UART (universal asynchronous receiver/transmitter). Accordingly, the low-speed USB interface unit (D17) transmits control signals output from the device driver (B15) to the network segregation control unit (D29), and also transmits control signals output from the network segregation control unit (D29) to the device driver (B15).

The high-speed signal switching unit (D13) operates as follows. When the high-speed interface signal conversion unit (D5) converts a Thunderbolt signal into a PCI Express interface signal, the high-speed signal switching unit (D13), in response to an operating-system selection signal output from the network segregation control unit (D29), selects one of an NVMe-standard M.2 SSD #1 (D19) on which an internal-network operating system is installed and an NVMe-standard M.2 SSD #2 (D21) on which an external-network operating system is installed, and performs signal switching such that a PCI Express interface signal is transmitted from the selected M.2 SSD. When the high-speed interface signal conversion unit (D5) converts a high-speed USB signal into a SATA interface signal or into a PCI Express interface signal, the high-speed signal switching unit (D13), based on the operating-system selection signal output from the network segregation control unit (D29), selects one of the M.2 SSD #1 (D19) storing the internal-network operating system and the M.2 SSD #2 (D21) storing the external-network operating system, and performs signal switching and transmission via a SATA interface or a PCI Express interface according to an interface supported by the selected M.2 SSD.

In general, a notebook PC (not shown) is internally equipped with an M.2 SSD (not shown) on which an operating system is installed.

In order to use the physical network segregation dongle (700) according to the present invention, the operating system installed in the notebook PC is duplicated onto the M.2 SSD #1 on which the internal-network operating system is installed and onto the M.2 SSD #2 on which the external-network operating system is installed, both of which are provided within the physical network segregation dongle (700). After completion of the duplication, the M.2 SSD originally installed in the notebook PC is formatted and repurposed as a built-in disk device for user data.

The network segregation control unit (D29) receives status information of the device driver (B15), which is generated according to the operation flow diagram illustrated in FIG. 6 and transmitted via the low-speed USB hub (D3) and the low-speed USB interface unit (D17). Based on the received status information, the network segregation control unit (D29) performs a network switching operation between an internal network and an external network (B3, B4) with respect to the network connection unit (D15), or controls the high-speed signal switching unit (D13) so as to select an operating system to be booted. The network segregation control unit (D29) then transmits status information regarding the booted operating system to the device driver (B15) via the low-speed USB interface unit (D17).

An LED display unit (D23) is configured to indicate whether an operating system for an internal network or an operating system for an external network is being booted. The LED display unit (D23) is driven based on a signal output from the network segregation control unit (D29), and its operation directly reflects the operation of the network selection display LED (405) provided in the network selector (400) illustrated in FIG. 4.

A network selection switch (D31) performs the same function as the network selection switch (401) provided in the network selector (400) illustrated in FIG. 4. Based on an internal-network or external-network selection signal output from the network segregation control unit (D29), the network selection switch (D31) enables selection, at a subsequent PC boot, of either an operating system for an internal network or an operating system for an external network.

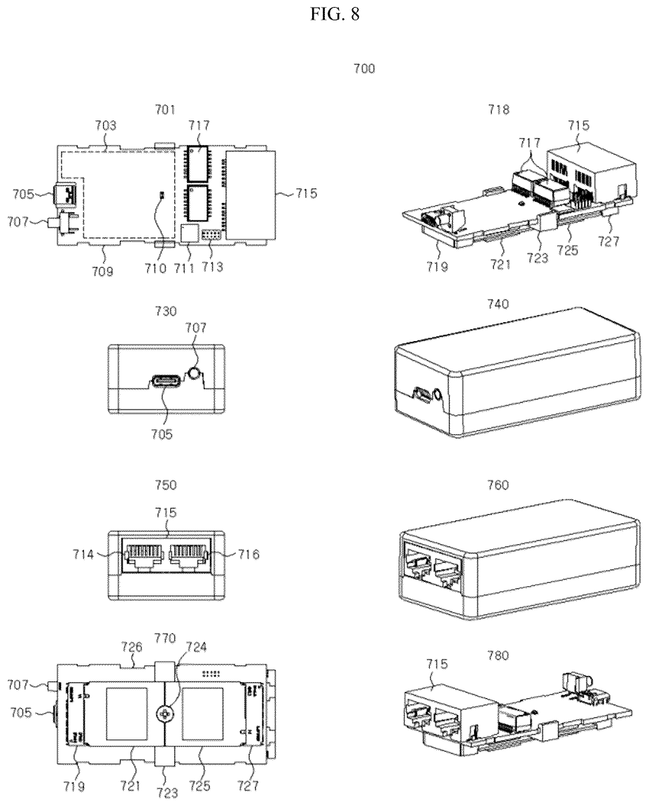

FIG. 8 illustrates an embodiment of a physical network segregation dongle (700) for a notebook PC, which is a hardware implementation of the block diagram shown in FIG. 7 according to the present invention. Major components are described below with reference to corresponding reference numerals.

An overall shape and configuration of the physical network segregation dongle (700) are illustrated in a front projection view (740) and a rear projection view (760) of the physical network segregation dongle.

A front portion (730) of the physical network segregation dongle is provided with a USB Type-C connector (705, corresponding to D1) and a network selection switch (707, corresponding to D31). A rear portion (750) of the physical network segregation dongle is provided with a single-body dual-type RJ45 Ethernet connector (715), which defines an internal-network port (714) to which an internal-network cable (B3) is connected and an external-network port (716) to which an external-network cable (B4) is connected.

With respect to an arrangement of major components corresponding to the block diagram illustrated in FIG. 7, components disposed on a top surface (700) of a physical network segregation dongle board include a USB Type-C connector (705, D1), a network selection switch (707, D31), a network segregation control unit (711), and a dual-type RJ45 Ethernet connector (715, corresponding to D25 and D27). In addition, although not illustrated in the block diagram of FIG. 7, a magnetic coil (717) is disposed between a network connection unit (D15) and the dual-type RJ45 Ethernet connector (715, D25, D27), and a programming port (713) for the control unit is disposed adjacent to the network segregation control unit (711).

Further, an LED (710) constituting an LED display unit (D23) is disposed at a substantially central position of the printed circuit board.

Components disposed on a bottom surface (770) of the physical network segregation dongle board include two M.2 connectors (719, 727), which are symmetrically arranged at respective end portions of the printed circuit board. An M.2 SSD support (723) is disposed at a central portion of the printed circuit board, the M.2 SSD support having a substantially “⊏”-shaped structure and including a recessed groove (not shown) formed at an inner side of an end portion thereof. The M.2 SSD support is inserted through an insertion guide groove (726) formed in the printed circuit board and is slid in a horizontal direction along the printed circuit board to move to a central position.

The M.2 SSD support (723) is manufactured as an aluminum extrusion and is provided, at a central portion thereof, with fixing holes (not shown) capable of simultaneously coupling two M.2 SSDs (721, 725). Accordingly, the two M.2 SSDs (721, 725) are simultaneously fixed using a single SSD fixing bolt (724). Since the fixing bolt does not penetrate the printed circuit board, it is unnecessary to form a through-hole at a central portion of the printed circuit board, which is already narrow in width. As a result, dense signal routing can be freely implemented at the central region of the printed circuit board.

Meanwhile, other components illustrated in the block diagram of FIG. 7 but not shown on the top surface (701) or the bottom surface (770) of the physical network segregation dongle board are disposed within a component placement region indicated by a dotted line, using one or both of the top surface and the bottom surface of the printed circuit board.

As described above, although the physical network segregation dongle (700) according to the embodiment illustrated in FIG. 7 and FIG. 8 differs in certain block components and external structural configurations from the physical network segregation control means (B2) for a desktop PC illustrated in FIGS. 2 and 4, the operation of the device driver (B15) implementing the operation flow diagram illustrated in FIG. 6 is identically applicable.

Although preferred embodiments of the present invention have been described in detail above, those skilled in the art will appreciate that various modifications and variations may be made without departing from the scope of the appended claims.

Modes for carrying out the present invention will be described as follows.

As illustrated in FIG. 2, operation of the device driver is represented by execution or final activation of a web browser according to an embodiment, wherein the web browser is displayed on a main screen and within virtual machine software, as shown on a monitor illustrated in FIG. 3.

In addition, forms applicable to a desktop PC for implementing physical network segregation based on a single PC include a physical network segregation card, a network segregation network dongle, and a network selector, as illustrated in FIG. 4.

Finally, an embodiment providing a usage environment for physical network segregation based on a single PC in a notebook PC is implemented by a physical network segregation dongle illustrated in FIG. 8, which is based on the block diagram illustrated in FIG. 7.

As described above, since the advent of personal computers, built-in disk devices have remained continuously connected upon booting of a PC, and network connections are also established immediately during the boot process. As a result, when a PC completes booting and begins normal operation, an environment inherently vulnerable to hacking and external attacks is maintained. Due to these circumstances, PC security has conventionally been achievable only through software-based security approaches.

Software-based security solutions operate by being installed on a PC and executed as software.

Accordingly, such solutions consume system resources including a CPU, main memory, and disk storage, and further require frequent security patches and software upgrades.

Moreover, from a user's perspective, it is difficult to clearly determine whether such security software is operating effectively or whether data leakage is actually being prevented.

In contrast, the single-PC-based physical network segregation card for desktop PCs and the physical network segregation dongle for notebook PCs according to the present invention physically separate an internal network from an external network, thereby providing a secure PC usage environment, at least with respect to the internal network. In addition, the physical network segregation card and the physical network segregation dongle according to the present invention consume little to no computing resources of the PC and do not require frequent security patches or software upgrades. Accordingly, the present invention exhibits high industrial applicability and is expected to receive significant attention and adoption in the field of PC security.

1. A single-personal computer (PC)-based physical network segregation system, comprising:
a first network adapter provided for a main screen when an operating system is booted;
a second network adapter provided for virtual machine software installed in the operating system;
a device driver installed in the operating system and configured to monitor a web browser executed on at least one of the main screen and the virtual machine software; and
physical network segregation controller including an interface converter configured to transmit and receive status information to and from the device driver, network connection means to which an internal-network cable and an external-network cable are connected, and a network segregation controller configured to generate network connection control signals and other control signals for the network connection means based on status information received through the interface converter,
wherein,
when the device driver detects that a web browser is started on the main screen, the device driver is configured to:
switch the first network adapter to a state of being used; and
switch the second network adapter to a state of not being used; and
simultaneously transmit, to the physical network segregation controller, status information indicating that the web browser of the main screen or the first network adapter is in a state of being used, such that the physical network segregation controller is configured to cause an internal network to be connected;
when the device driver detects that a web browser is started on the virtual machine software, the device driver is configured to:
switch the second network adapter to a state of being used;
switch the first network adapter to a state of not being used; and
simultaneously transmit, to the physical network segregation controller, status information indicating that the web browser of the virtual machine software or the second network adapter is in a state of being used, such that the physical network segregation controller is configured to cause an external network to be connected; and
when the device driver detects that web browsers are started on both the main screen and the virtual machine software, the device driver is configured to:
switch the first or second network adapter corresponding to a web browser that is started or activated later to a state of being used;
switch the first or second network adapter corresponding to a web browser that is started or activated earlier to a state of not being used; and
simultaneously transmit, to the physical network segregation controller, status information corresponding to the later-started or later-activated web browser or the network adapter in the state of being used, such that the physical network segregation controller is configured to cause the internal network to be connected when the later-started or later-activated web browser is the web browser of the main screen or when the first network adapter is in use, and causes the external network to be connected when the later-started or later-activated web browser is the web browser of the virtual machine software or when the second network adapter is in use, thereby maintaining physical network segregation.

2. The system of claim 1,
wherein the device driver, upon detecting input of a preset hot key, is configured to alternately switch, at predetermined time intervals, the first network adapter provided for the main screen and the second network adapter provided for the virtual machine software between a state of being used and a state of not being used, such that a web browser on the main screen and a web browser on the virtual machine software are continuously displayed from a user's perspective without an apparent network disconnection, while physical network segregation is maintained.

3. The system of claim 1,
wherein, when the operating system is booted, the physical network separation controller is configured to transmit, through the interface converter, to the device driver status information indicating whether the operating system has been booted by an internal-network operating system or by an external-network operating system.

4. The system of claim 1,
wherein, when the operating system is booted by an external-network operating system, the device driver is configured to maintain, while the virtual machine software is running, a network, a clipboard, a shared folder, a printer, video, and a microphone for the virtual machine software in a state of being enabled; and
wherein, when the operating system is booted by an internal-network operating system, the device driver is configured to maintain, while the virtual machine software is running, the network for the virtual machine software in a state of being enabled, but maintains the clipboard, the shared folder, the printer, the video, and the microphone in a state of being disabled.

5. A single-personal computer (PC)-based physical network separation system, comprising:
a first network adapter provided for a main screen when an operating system boots;
a second network adapter provided for virtual machine software installed in the operating system;
a device driver installed in the operating system and configured to monitor a web browser executed on at least one of the main screen and the virtual machine software; and
physical network separation controller connected to the device driver through interface and to which an internal-network cable and an external-network cable are connected,
wherein, when the device driver detects that no web browser is started on the main screen and also detects that no web browser is started on the virtual machine software, the device driver is configured to:
switch both the first network adapter and the second network adapter to a state of being not used; and
simultaneously transmit the physical network separation controller status information indicating that no web browser is started on both the main screen and the virtual machine software, or that both the first network adapter and the second network adapter are in the state of being not used,
such that the physical network separation controller is configured to maintain a state in which both the internal network and the external network are simultaneously blocked.

6. A single-personal computer (PC)-based physical network separation system, comprising:
a first network adapter provided for a main screen when an operating system boots;
a second network adapter provided for virtual machine software installed in the operating system;
a device driver installed in the operating system and configured to monitor a web browser that is started or later selected and activated on at least one of the main screen and the virtual machine software; and
physical network separation controller connected to the device driver through interface and to which an internal-network cable and an external-network cable are connected,
wherein, when the device driver detects that a web browser is started or later selected and activated on the main screen and/or on the virtual machine software and transmits corresponding status information to the physical network separation controller, the physical network separation controller is configured to perform the following operations:
when it is determined that a web browser is started only on the main screen, causing an internal network to be connected and simultaneously transmitting network connection information to the device driver such that the device driver switches the first network adapter of the main screen to a state of being used and switches the second network adapter of the virtual machine software to a state of being not used;
when it is determined that a web browser is started only on the virtual machine software, causing an external network to be connected and simultaneously transmitting network connection information to the device driver such that the device driver switches the second network adapter of the virtual machine software to a state of being used and switches the first network adapter of the main screen to a state of being not used;
when it is determined that web browsers are started on both the main screen and the virtual machine software and a current network connection state corresponds to an external network, causing the internal network to be connected and simultaneously transmitting network connection information to the device driver such that the device driver switches the first network adapter of the main screen to a state of being used and switches the second network adapter of the virtual machine software to a state of being not used, and, after a predetermined period of time has elapsed, causing the external network to be connected and simultaneously transmitting network connection information to the device driver such that the device driver switches the first network adapter of the main screen to a state of being not used and switches the second network adapter of the virtual machine software to a state of being used, repeatedly; and
when it is determined that web browsers are started on both the main screen and the virtual machine software and a current network connection state corresponds to an internal network, causing the external network to be connected and simultaneously transmitting network connection information to the device driver such that the device driver switches the second network adapter of the virtual machine software to a state of being used and switches the first network adapter of the main screen to a state of being not used, and, after a predetermined period of time has elapsed, causing the internal network to be connected and simultaneously transmitting network connection information to the device driver such that the device driver switches the second network adapter of the virtual machine software to a state of being not used and switches the first network adapter of the main screen to a state of being used, repeatedly.

7. A single personal computer (PC)-based physical network separation device, comprising:
interface converter configured to receive, from a device driver, status information regarding a web browser that is started or later activated on a main screen and/or on virtual machine software, or status information regarding a network adapter that is later set to a state of being used;
a network separation controller connected to the interface converter and configured to generate an internal-network selection signal or an external-network selection signal based on the received status information; and
network connector configured to select and connect an internal network or an external network according to the network selection signal output from the network separation controller,
wherein the network separation controller is configured to cause the network connector to be connected to the internal network when the status information received through the interface converter indicates that the web browser of the main screen is in an activated state, and cause the network connector to be connected to the external network when the status information indicates that the web browser of the virtual machine software is in an activated state.

8. The device of claim 7, further comprising:
network selector connected to the physical network separation controller and including a switch configured to allow a user to select whether a PC is to be booted by an internal-network operating system or by an external-network operating system; and
a first M.2 adapter card to which an M.2 SSD having the internal-network operating system installed is coupled, and a second M.2 adapter card to which an M.2 SSD having the external-network operating system installed is coupled, the first and second M.2 adapter cards being respectively connected to the physical network separation controller via cables,
wherein, when the user actuates the switch of the network selector and the network separation controller determines that a selected operating system is the same as a currently booted operating system, and when the user subsequently selects one of Shutdown, Hibernate, or Restart such that the PC is powered off, the network separation controller maintains a reset signal in a released state for the M.2 adapter card coupled to the M.2 SSD having the currently booted operating system so as to allow rebooting by the same operating system, and simultaneously maintains a reset signal in a set state for the M.2 adapter card coupled to the M.2 SSD having a non-selected operating system so as to prevent booting thereof; and
wherein, when the network separation controller determines that the selected operating system is different from the currently booted operating system, and when the user subsequently selects one of Shutdown, Hibernate, or Restart such that the PC is powered off, the network separation controller is configured to maintain the reset signal in the set state for the M.2 adapter card coupled to the M.2 SSD having the currently booted operating system so as to prevent rebooting thereof, and simultaneously maintains the reset signal in the released state for the M.2 adapter card coupled to the M.2 SSD having the selected different operating system so as to allow booting of the selected operating system.

9. The device of claim 8,
wherein the network connector and the network selector are respectively connected to the physical network separation controller via separate cables, such that the network connector and the network selector are physically separated from each other.

10. The device of claim 8, further comprising:
a first connector configured to connect a built-in disk device for internal-network user data;
a second connector configured to connect a built-in disk device for external-network user data;
a bidirectional multiplexer/demultiplexer respectively connected to disk-device connection pins of the first connector and the second connector; and
a third connector connected to the bidirectional multiplexer/demultiplexer and configured to connect to a built-in disk-device connector provided on a motherboard,
wherein,
when the device is booted by an internal-network operating system, the network separation controller is configured to maintain a disk selection signal of the bidirectional multiplexer/demultiplexer in a state connected to the first connector, and
when the device is booted by an external-network operating system, the network separation control controller is configured to maintain the disk selection signal in a state connected to the second connector; and
wherein, in response to a user operating a built-in user-data disk connection/disconnection switch provided in the network selector,
when a power switching signal output from the network separation controller is at a LOW level, power is supplied to the bidirectional multiplexer/demultiplexer such that the built-in disk device for internal-network user data or the built-in disk device for external-network user data is in a connected state; and
when the power switching signal is at a HIGH level, power supply to the bidirectional multiplexer/demultiplexer is cut off such that, regardless of a state of the disk selection signal, both the built-in disk device for internal-network user data and the built-in disk device for external-network user data are in a disconnected state.

11. A single-personal computer (PC)-based physical network separation dongle for a notebook PC, comprising:
a universal serial bus (USB) Type-C connector configured to be connected to a notebook PC;
a low-speed USB hub connected to low-speed USB pins provided in the USB Type-C connector and configured to generate and expand a first low-speed USB interface signal and a second low-speed USB interface signal;
a high-speed interface signal converter connected to high-speed USB pins provided in the USB Type-C connector and configured to convert signals into an interface supported by an M.2 SSD on which an operating system is installed;
high-speed interface signal switch connected to the high-speed interface signal converter;
an internal-network M.2 SSD on which an internal-network operating system is installed and an external-network M.2 SSD on which an external-network operating system is installed, each being connected to the high-speed interface signal switch through a respective M.2 connector;
low-speed interface converter connected to the low-speed USB hub by the first low-speed USB interface signal;
a network separation controller connected to the low-speed interface converter and configured to receive status information transmitted from a device driver or to output whether a booted operating system corresponds to the internal-network M.2 SSD or the external-network M.2 SSD;
network connector connected to the low-speed USB hub by the second low-speed USB interface signal and configured, according to an internal-network or external-network network selection signal output from the network separation controller, to connect an internal network or an external network;
a power supply unit connected to power pins provided in the USB Type-C connector and configured to generate power for internal use; and
a printed circuit board on which the above components are mounted,
wherein the network separation controller causes the network connector to be connected to the internal network when status information received from the device driver through the low-speed interface converter indicates that a web browser is a web browser of a main screen or that a network adapter of the main screen is in a state of being used, and
causes the network connector to be connected to the external network when the status information indicates that the web browser is a web browser of virtual machine software or that a network adapter of the virtual machine software is in a state of being used.

12. The single-PC-based physical network separation dongle of claim 11,
wherein the network separation controller transmits, through the low-speed interface converter, to the device driver status information indicating whether the operating system has been booted by the internal-network M.2 SSD or by the external-network M.2 SSD.

13. The single-PC-based physical network separation dongle of claim 11,
further comprising an LED display unit connected to the network separation controller, wherein the LED display unit is configured to display, according to control signals output from the network separation controller, whether the operating system has been booted by the internal-network M.2 SSD or by the external-network M.2 SSD, and whether a network currently connected by the network connector is an internal network or an external network.

14. The single-PC-based physical network separation dongle of claim 11, further comprising:
an M.2 SSD support structure configured to slide in a horizontal direction along a printed circuit board through a groove formed in the printed circuit board, the M.2 SSD support structure serving as a mounting support for an internal-network M.2 SSD and an external-network M.2 SSD; and
a fixing bolt configured to secure the M.2 SSDs,
wherein the two M.2 SSDs are arranged to face each other with a fixing hole of the M.2 SSD support structure as a center, and are secured to the fixing hole of the M.2 SSD support structure using a single fixing bolt, and
wherein the fixing bolt does not penetrate the printed circuit board when the two M.2 SSDs are secured.
